(19) United States
(12) Patent Application Publication
(10) Pub. No.: US 2012/0318195 A1
(43) Pub. Date: Dec. 20, 2012

(54) COATING DEVICE

(75) Inventor: Shoa-Kai PEI, Tu-Cheng (TW)

(73) Assignee: HON HAI PRECISION INDUSTRY CO., LTD., Tu-Cheng (TW)

(21) Appl. No.: 13/226,508

(22) Filed: Sep. 7, 2011

(30) Foreign Application Priority Data
Jun. 15, 2011 (TW) 100120808

(51) Int. Cl. B05C 11/00

(52) U.S. Cl. 118/620

(57) ABSTRACT

A coating device includes a main body and at least one ionic-wind generating device. The main body includes a first surface, a second surface opposite to the first surface, and a plurality of receiving holes passing through the first surface and the second surface. Each receiving hole is used for receiving an element which needs to be coated and includes an inlet for letting the element to enter the receiving hole. The inlet is positioned on the first surface. The at least one ionic-wind generating device is positioned on one side of the main body, and is used for blowing ionic-wind towards a direction opposite to the second surface, thus blowing ionic-wind towards the element before the element enters the inlet.

### BACKGROUND

1. Technical Field

The present disclosure relates to coating devices and, particularly, to a coating device, which can remove dust and static electricity attached on elements, which need to be coated.

2. Description of Related Art

Before lenses are received in a vapor deposition chamber, it is easy for dust to contaminate the lens, this will have a great influence on the coating quality of the lens during the vapor deposition process.

Therefore, it is desirable to provide a coating device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a coating device, according to an exemplary embodiment.

FIG. 2 is similar to FIG. 1, but viewed from a different angle.

FIG. 3 is a partially cross-sectional view of the coating device of FIG. 1, when a shielding cover is received in a through hole.

### DETAILED DESCRIPTION

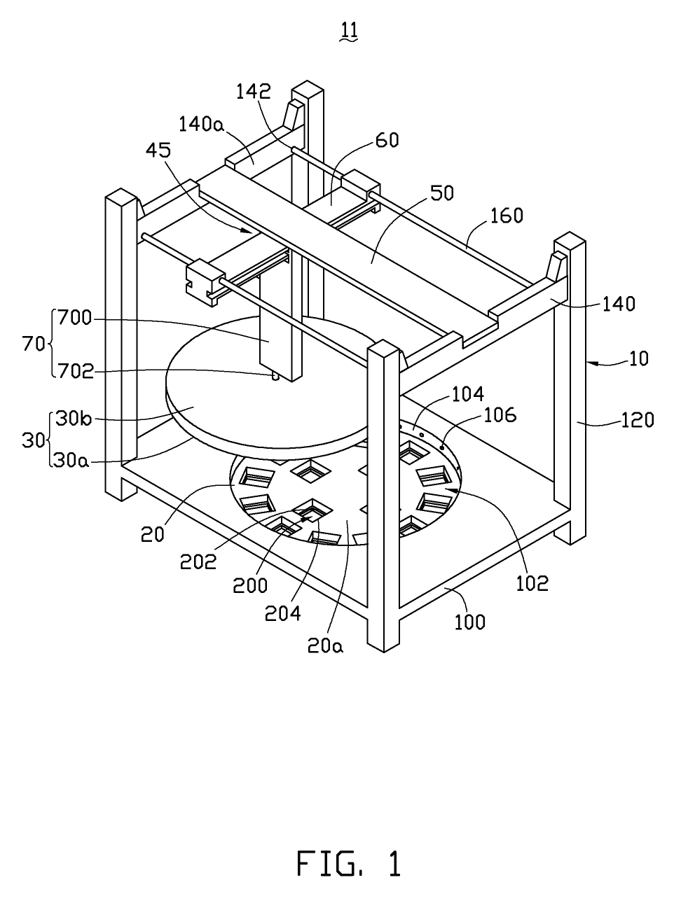

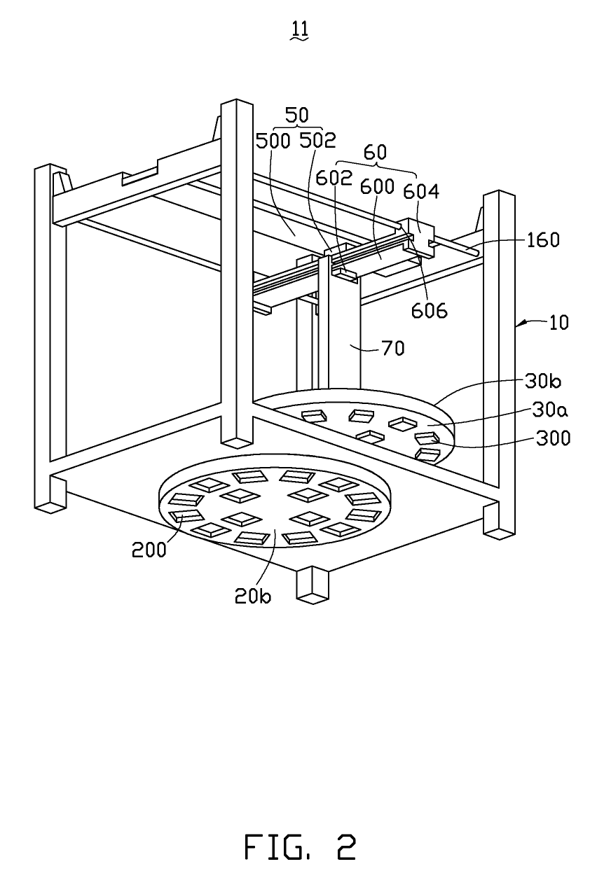

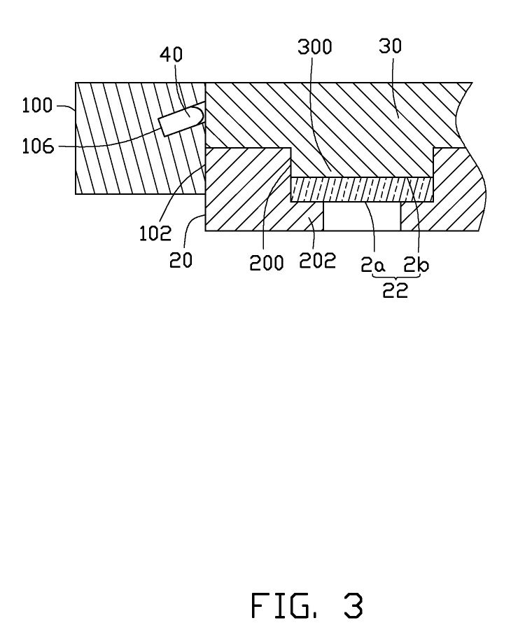

Referring to FIGS. 1-3, a coating device 11, according to an exemplary embodiment, is used for coating a number of lenses 22. Each lens 22 includes a need-to-be-coated surface 2a and an opposite rear surface 2b.

The coating device 11 includes a supporting frame 10, a main body 20, a shielding cover 30, a number of ionic-wind generating devices 40, and a driving device 45.

The supporting frame 10 includes a cuboid bottom plate 100, four vertical poles 120, two horizontal poles 140, and two guiding poles 160. The bottom plate 100 defines a round through hole 102, and includes an inner sidewall 104 bounding the through hole 102. The inner sidewall 104 defines a number of cylindrical receiving holes 106. Each receiving hole 106 is inclined within the inner sidewall 104 and is in communication with the through hole 102. The four vertical poles 120 are perpendicularly fixed to the four corners of the bottom plate 100. The two horizontal poles 140 are parallel to each other. Each of the two horizontal poles 140 is connected between two adjacent vertical poles 120.

Each horizontal pole 140 has a fixing surface 140a facing the other horizontal pole 140. Each fixing surface 140a defines two round mounting holes 142 arranged on the two ends of the corresponding horizontal pole 140. The two guiding poles 160 are connected between the two horizontal poles 140 and are parallel to each other. Each guiding pole 160 is cylindrical, and the diameter of each guiding pole 160 is slightly smaller than that of the mounting hole 142, and thus the two ends of the guiding poles 160 can be firmly received in the corresponding two mounting holes 142.

The main body 20 is disk-shaped, and the diameter of the main body 20 is slightly smaller than that of the through hole 102. The main body 20 includes a first surface 20a and a second surface 20b opposite to the first surface 20a. The main body 20 defines a number of receiving holes 200 for loading the lenses 22. Each receiving hole 200 extends though the first surface 20a and the second surface 20b. A protruding ring 202 perpendicularly extends from the inner sidewall of the receiving hole 200 adjacent to the second surface 20b. The receiving hole 200 includes an inlet 204 adjacent to the first surface 20a for allowing the lenses 22 to enter the receiving hole 200. The receiving hole 200 is used for receiving the lenses 22 and loading the lenses 22 on the protruding ring 202.

The shielding cover 30 is disk-shaped, the diameter of the shielding cover 30 is slightly smaller than that of the through hole 102. The shielding cover 30 has a round top surface 30a which has a number of protrusions 300 corresponding to the receiving holes 200 and a bottom surface 30b. The shape of the protrusion 300 is substantially the same as the shape of the inlet 204, and thus the protrusions 300 can be received in the receiving holes 200. When the protrusions 300 are received in the receiving holes 200, the distance between each protrusion 300 and the protruding ring 202 is larger than or equal to the thickness of the lens 22.

The shape of the ionic-wind generating device 40 is substantially the same as that of the receiving hole 106, and used for generating ionic-wind. An included angle between the first surface 20a and the blowing direction of the ionic-wind generating device 40 is about 5° to about 25°. In this embodiment, the included angle is about 15°.

The driving device 45 includes a horizontal linear motor 50, a vertical linear motor 60, and a cylinder 70. The horizontal linear motor 50 includes a strip-shaped horizontal stator 500 and a horizontal forcer 502. The length of the horizontal stator 500 is larger than the distance between the two horizontal poles 140. The horizontal forcer 502 is slidably arranged on the horizontal stator 500, and can be driven by the horizontal stator 500 to move along the horizontal stator 500.

The vertical motor 60 includes a strip-shaped vertical stator 600, a vertical forcer 602, and two guiding blocks 604. The vertical forcer 602 is slidably arranged on the vertical stator 600, and can be driven by the vertical stator 600 to move along the vertical stator 600. The two guiding blocks 604 are arranged on the two ends of the vertical stators 600. Each guiding block 604 defines a cylinder-shaped guiding hole 606. Both of the axial directions of the two guiding holes 606 are perpendicular to the moving direction of the vertical stator 600. The distance between the two guiding holes 606 is equal to the distance between the two mounting holes 142.

The cylinder 70 includes a cylinder block 700 and a piston rod 702 extending from the cylinder block 700. The piston rod 702 can be driven by the cylinder block 700 to move towards or away from the cylinder block 700.

In assembly, the main body 20 is welded to the through hole 102. The protruding ring 202 is away from the horizontal poles 140 with respect to the inlet 204. The receiving hole 106 is adjacent to the first surface 20a with respect to the second surface 20b. The ionic-wind generating devices 40 are received in the receiving holes 106, and blow ionic-wind towards the upper inclined direction with respect to the inner sidewall 104. The two ends of the horizontal stator 500 are respectively fixed on the middle of the two horizontal poles 140. The horizontal forcer 502 faces the main body 20. The horizontal forcer 502 is fixed on the middle of the vertical stator 600, and the vertical stator 600 faces the main body 20. The two guiding poles 160 are inserted into the two guiding holes 606. The two ends of the two guiding poles 160 are inserted into the corresponding mounting holes 142, and thus the two guiding poles 160 are parallel to the horizontal stator 500, the vertical stator 600 is perpendicular to the horizontal stator 500. The vertical forcer 602 is fixed on one side of the cylinder block 700 away from the piston rod 702. The extension direction of the piston rod 702 is perpendicular to the direction of the vertical stator 600. The piston rod 702 is perpendicularly fixed on the middle of the bottom surface 30b of the shielding cover 30.

In use, the bottom plate 100 of the supporting frame 10 is horizontally arranged on a coating vacuum (not shown), and the second surface 20b faces a target (not shown). The shielding cover 30 does not shield the main body 20. The ionic-wind generating devices 40 are turned on to blow ionic-wind towards the lenses 22 when the lenses 22 move to the main body 20. During the above process, dust and static electricity attached on the need-to-be-coated surface 2a of the lenses 22 is blown off. The lenses 22 pass through the inlet 204 to be resisted on the protruding ring 202. The horizontal linear motor 50 first drives the vertical linear motor 60 to drive the cylinder 70 and the shielding cover 30 to move towards the middle of the horizontal stator 500 along the direction of the horizontal stator 500. Then the vertical linear motor 60 drives the cylinder 70 and the shielding cover 30 to move towards the middle of the vertical stator 600 along the direction of the vertical stator 600, at this time, the shielding cover 30 is arranged over the through hole 102. The cylinder 70 drives the shielding cover 30 to move downwards to cover the first surface 20a of the main body 20, and thus the protrusions 300 are received in the receiving holes 200. In the above process, the ionic-wind generating devices 40 blow ionic-wind towards the shielding cover 30, and thus the dust and the static electricity contaminating the shielding cover 30 is blown off.

The shielding cover 30 is moved into the through hole 102, and the protrusions 300 move into the receiving holes 200 and cover the rear surface 2b of the lenses 22. At this time, the ionic-wind generating device 40 is turned off. Then, the coating device 11 starts to coat the lenses 22. During the coating process, because the shielding cover 30 is fitted with the through hole 102, the target ion cannot enter the through hole 102. Further, even if the ion enters the through hole 102, because the protrusions 300 are fitted with the receiving holes 200, the ion entering the through hole 102 cannot enter the receiving hole 200 to contaminate the rear surface 2b of the lenses 22.

In other embodiments, during the design of the coating device 11, the main body 20 and the driving device 45 also can be fixed on the inner sidewall of the vacuum (not shown), and thus the supporting frame 10 can be omitted.

In other embodiments, if only the receiving holes 200 can load the lenses 22, the protruding ring 202 also can be omitted. Such as, the receiving hole 200 is an inverted platform shaped, and the top opening is larger than the bottom opening, the bottom opening is smaller than the lenses 22.

In other embodiments, the shielding cover 30 can be held by hand, and the driving device 45 also can be omitted.

In other embodiments, the coating device 11 can be used for loading other elements, which need to be coated.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A coating device comprising:
a main body comprising a first surface and a second surface opposite to the first surface, and defining a plurality of receiving holes extending through the first surface and the second surface, each receiving hole configured for receiving an element which needs to be coated and comprising an inlet for letting the element to enter the receiving hole, the inlet positioned on the first surface; and
at least one ionic-wind generating device positioned on one side of the main body, and configured for blowing ionic-wind towards a direction opposite to the second surface, and thus to blow ionic-wind towards the element before the element enters the inlet.

2. The coating device of claim 1, wherein an included angle between the first surface and the blowing direction of the ionic-blow device is about 5° to about 25°.

3. The coating device of claim 1, wherein the angle between the first surface and the blowing direction of the ionic-wind generating device is about 15°.

4. The coating device of claim 1, wherein the coating device further comprises a shielding cover which is corresponding to the first surface and is able to move with respect to the first surface, the shielding cover is configured for moving towards the first surface to shield the first surface when the element is loaded in the receiving hole.

5. The coating device of claim 4, wherein the shielding cover comprises a plurality of protrusions spatially corresponding to the receiving holes, the shape of each protrusion is the same as that of a respective receiving hole, the protrusions are configured for sealing the receiving holes when the shielding cover shields the first surface.

6. The coating device of claim 4, wherein the coating device further comprises a supporting frame, the supporting frame comprises a bottom plate which defines a through hole corresponding to the main body, the main body is received in the through hole.

7. The coating device of claim 6, wherein the bottom plate further comprises an inner sidewall facing and bounding the through hole, the inner sidewall defines at least one receiving hole positioned adjacent to the first surface, each ionic-wind generating device is received in a corresponding receiving hole.

8. The coating device of claim 6, wherein the coating device further comprises a driving device positioned on the supporting frame, the driving device is configured for driving the shielding cover to move towards the first surface.

9. The coating device of claim 8, wherein the driving device further comprises a cylinder which comprises a cylinder block and a piston rod, the cylinder block is positioned on the side of the shielding cover away from the main body, the piston rod is driven by the cylinder block and is fixed on the shielding cover.

10. The coating device of claim 9, wherein the driving device further comprises a vertical motor, the vertical motor comprises a vertical stator and a vertical forcer, the vertical stator is substantially strip-shaped, and is positioned on a side of the cylinder away from the shielding cover, the vertical forcer is slidably positioned on the vertical stator, and is capable of being drove by the vertical stator to move along the vertical stator, the vertical forcer is connected to the cylinder block, the vertical stator is perpendicular to an extension direction of the piston rod.

11. The coating device of claim 10, wherein the driving device further comprises a horizontal linear motor, the horizontal linear motor comprises a stripe-shaped horizontal stator and a horizontal forcer, the horizontal stator is positioned on a side of the vertical linear motor away from the horizontal linear motor, the horizontal forcer is slidably positioned on the horizontal stator, and is capable of being drove by the horizontal stator along the horizontal stator, the horizontal forcer is connected to the vertical stator, and is perpendicular to the direction of the extension direction of the piston rod and perpendicular to the vertical stator.

12. The coating device of claim 11, wherein the supporting frame further comprises four vertical poles, two horizontal poles, and two guiding poles, the four vertical poles are perpendicular to and connected to the bottom plate, the two horizontal poles are opposite to each other, each horizontal pole connects two corresponding vertical poles, two ends of the horizontal stator are respectively positioned on the two horizontal poles, each guiding pole is connected to the two horizontal poles, the two guiding poles are positioned on two opposite sides of the horizontal stator, and is parallel to the horizontal stator, the vertical linear motor further comprises two guiding blocks fixed on two ends of the vertical stator, each guiding block is sleeved over a corresponding guiding pole and is capable of moving along the corresponding guiding pole.
